(19) United States
(12) Patent Application Publication
(10) Pub. No.: US 2009/0326922 A1
(43) Pub. Date: Dec. 31, 2009

(54) CLIENT SIDE RECONCILIATION OF TYPOGRAPHICAL ERRORS IN MESSAGES FROM INPUT-LIMITED DEVICES

(75) Inventors: Frank L. Jania, Chapel Hill, NC (US); Travis M. Grigsby, Austin, TX (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/164,280

(22) Filed: Jun. 30, 2008

(51) Int. Cl. G06F 17/27

(52) U.S. Cl. 704/9

(57) ABSTRACT

A method for reconciling typographical errors, includes: receiving an electronic text message from a pervasive device with limited input keypads on a receiving device configured with a messaging application; determining an input protocol of the pervasive device; examining the electronic text message for words that are not in the messaging application's dictionary; identifying words that are not in the messaging application's dictionary; mapping each of the identified words to a set of keystrokes used to produce each of the identified words based on a series of input protocols that the receiving device has stored in a memory; utilizing each set of keystrokes from each of the input protocols in an algorithm to compute each permutation of the keystrokes; checking the computed permutations against the messaging application's dictionary to determine viable matches of the computed permutations; and presenting the viable matches to a user of the receiving device.

### BACKGROUND

This invention relates generally to electronic text communications, and more particularly to a method for correcting typographical errors in electronic communications that originate from pervasive devices with limited input capabilities.

Electronic communication, such as electronic mail (email) and instant messaging (IM), has become a central feature of modern life and users have come to expect to receive electronic mail messages and instant messages at any time and in virtually any place. For example, during the course of one day of travel, a user may send or receive electronic communications at a home desktop computer in the early morning, an office desktop computer in midmorning, via a pervasive device such as a cell phone, personal digital assistant, or wearable computing device in a taxi on the way to the airport, on a laptop computer via a wireless local area network while waiting in the airport lounge, via an in-flight telephone on the airplane, and in a hotel room via a high-speed Internet connection provided by the hotel at the end of the day.

The widespread proliferation and availability of electronic communication messaging has provided an efficient method to communicate information. The utilization of the Internet to distribute electronic communications has connected people around the world to form a so-called World Wide Web. In fact electronic messaging with its near instantaneous delivery from sender to receiver has made it the preferred method of personal and business communication where hardcopy signatures are not required. In addition the ease of use and minimal cost of distribution has led to mass email to large distribution lists, as well as using email and IM as a broad collaborative tool.

Pervasive devices with limited input keypads (input-limited devices) are configured with predictive text technology such as T9, Multi-tap, iTap, eZiText, etc. For example, T9, which stands for text on 9 keys, is a predictive text technology for mobile phones. The objective of T9 is to make it easier to type text messages. T9 allows words to be entered by a single keypress for each letter, as opposed to the multi-tap approach used in the older generation of mobile phones in which several letters are associated with each key, and selecting one letter often requires multiple keypresses. T9 combines the groups of letters on each phone key with a fast-access dictionary of words. T9 utilizes the dictionary to look up all words corresponding to the sequence of keypresses and orders them by frequency of use. As T9 gains familiarity with the words and phrases a user commonly uses, T9 speeds up the process by offering the most frequently used words first, and then lets the user access other choices with one or more presses of a predefined Next key. The dictionary may be expanded by adding missing words, enabling the missing words to be recognized in the future. After introducing a new word, the next time the user tries to produce that word T9 will add it to the predictive dictionary.

### SUMMARY

Embodiments of the present invention include a method for reconciling typographical errors, the method includes: receiving an electronic text message from a pervasive device with limited input keypads on a receiving device configured with a messaging application; determining an input protocol of the pervasive device; examining the electronic text message for one or more words that are not in the messaging application's dictionary; identifying the one or more words that are not in the messaging application's dictionary; mapping each of the identified one or more words to a set of keystrokes used to produce each of the identified one or more words based on a series of input protocols that the receiving device has stored in a memory; utilizing each set of keystrokes from each of the input protocols in an algorithm to compute each permutation of the keystrokes; checking the computed permutations against the messaging application's dictionary to determine viable matches of the computed permutations; and presenting the viable matches to a user of the receiving device.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a method for typographical error correction of a received electronic communication according to embodiments of the invention.

FIG. 2 illustrates a system for implementing embodiments of the invention.

The detailed description explains the preferred embodiments of the invention, together with advantages and features, by way of example with reference to the drawings.

### DETAILED DESCRIPTION

The explosive growth in the use of pervasive devices to exchange electronic mail (email) and instant messaging (IM) between people across the globe via the World Wide Web on the Internet has intensified the need for typographical correction of received electronic communications from pervasive devices with limited input capabilities.

Embodiments of the invention provide a method and system for reconciling typographical errors in a received message as displayed on a recipient's messaging application. Embodiments of the invention recognize typographical errors in a received electronic message, by comparing the errors to known historical errors that have been generated previously by the type of input protocol (T9, multi-tap, etc.) of the sending device. In embodiments of the invention, the receiving device is configured to identify the type of sending device and sending device's input protocol based on information contained in the message header. By utilizing knowledge of the input protocol employed by the sending device, the receiving device is configured to recognize words that are erroneous, by comparing the received words to known errors based on the type of input device.

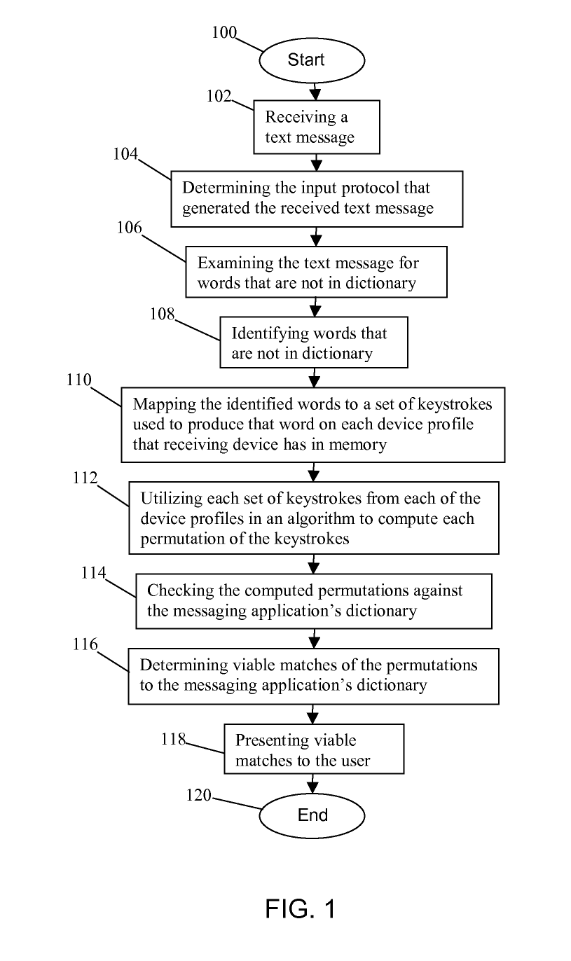

FIG. 1 illustrates a method for typographical error correction of a received electronic communication according to embodiments of the invention. The process starts (block 100) with a messaging application receiving a text message (block 102). The messaging application determines the input protocol of the sending device that generated the received text message (block 104), examines the text message for words that are not in the messaging application's dictionary (block 106), and identifies words that are not in the messaging application's dictionary (block 108). The messaging application maps the identified words to a set of keystrokes used to produce that word on each device profile that the receiving device has in memory (block 110). The messaging application utilizes each set of keystrokes from each of the device profiles in an algorithm to compute each permutation of the keystrokes (block 112), and checks the computed permutations against the messaging application's dictionary (block 114) to determine viable matches of the permutations to the messaging application's dictionary (block 116). Subsequently, the messaging application presents the viable matches to the user (block 118), and the process concludes (block 120).

In embodiments of the invention, a graphical user interface (GUI) is configured to user preferences to present the viable matches for the typographical corrections, such as drop down menus with word suggestions that appear automatically when a cursor is placed over the erroneous word. In embodiments of the invention, the messaging application may make typographical error determinations based on a threshold of previous errors corrected with respect to a particular type of message sending device, and automatically provide the most common typographical correction in place of the erroneous word. In addition based on user acceptance of the suggested correction, a message application may optimize subsequent error corrections presented to a user. In addition, embodiments of the invention may utilize grammar analysis instead of dictionary analysis to determine proper word usage in instances where identical keystrokes result in a plurality of properly spelled words. In this instance, the usage context of the word is used to determine a recommendation to a user, as well as user related information, such as their calendar entries or Web browsing history.

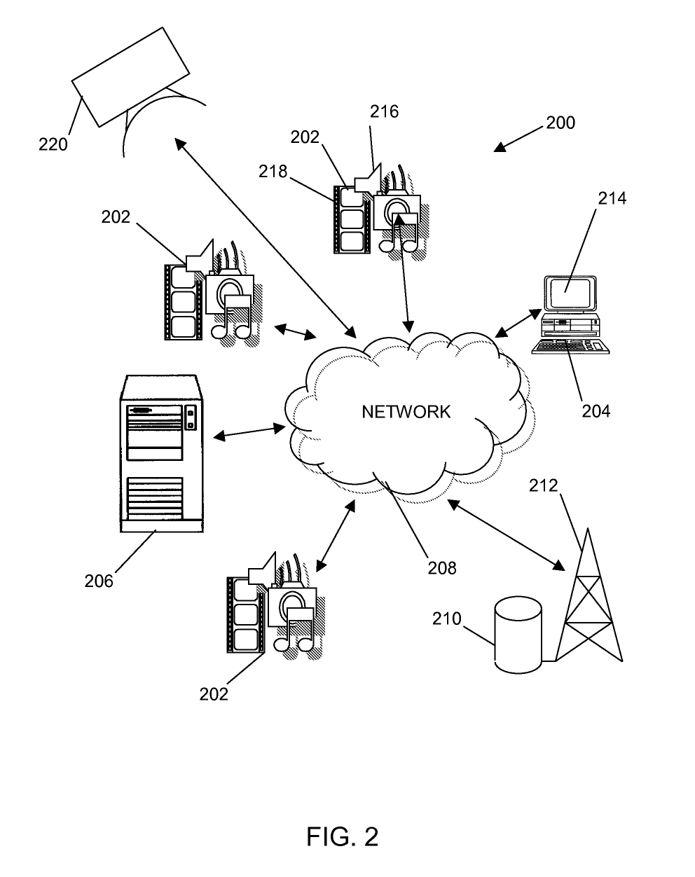

FIG. 2 is a block diagram of an exemplary system 200 configured for correcting typographical errors in electronic communications that originate from pervasive devices with limited input capabilities. The system 200 includes multimedia devices 202, and desktop computer devices 204 configured with display capabilities 214. The multimedia devices 202 may be mobile communication and entertainment devices, such as cellular phones and mobile computing devices that are wirelessly connected to a network 208. The multimedia devices 202 have video displays 218 and audio outputs 216. The multimedia devices 202 and desktop computer devices 204 may be configured with software with a GUI for carrying out the typographical correction of embodiments of the invention. The network 208 may be any type of known network including a fixed wire line network, cable and fiber optics, over the air broadcasts, satellite 220, local area network (LAN), wide area network (WAN), global network (e.g., Internet), intranet, etc. with data/Internet capabilities as represented by server 206. Communication aspects of the network are represented by cellular base station 210 and antenna 212. In a preferred embodiment, the network 208 is a LAN and each remote device 202 and desktop device 304 executes a user interface application (e.g., web browser) to contact the server system 206 through the network 208. Alternatively, the remote devices 202 and 204 may be implemented using a device programmed primarily for accessing network 208 such as a remote client.

The typographical correction software, of embodiments of the invention, may be resident on the individual multimedia devices 202 and desktop computers 204, or stored within the server 206 or cellular base station 210.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for reconciling typographical errors, wherein the method comprises:
receiving an electronic text message from a pervasive device with limited input keypads on a receiving device configured with a messaging application;
determining an input protocol of the pervasive device;
examining the electronic text message for one or more words that are not in the messaging application's dictionary;
identifying the one or more words that are not in the messaging application's dictionary;
mapping each of the identified one or more words to a set of keystrokes used to produce each of the identified one or more words on a series of input protocols that the receiving device has stored in a memory;
utilizing each set of keystrokes from each of the input protocols in an algorithm to compute each permutation of the keystrokes;
checking the computed permutations against the messaging application's dictionary to determine viable matches of the computed permutations; and
presenting the viable matches to a user of the receiving device.

2. The method of claim 1, wherein a graphical user interface (GUI) is configured to present the viable matches.

3. The method of claim 2, wherein the graphical user interface (GUI) is configured with drop down menus for automatically displaying the viable matches when a cursor is placed over a word not in the messaging application's dictionary.

4. The method of claim 1, wherein the messaging application determines typographical errors based on a threshold of previous errors corrected with respect to a particular type of pervasive device;
wherein the messaging application automatically provides the most common typographical correction in place of the typographical error; and
wherein in response to a user acceptance of the typographical correction, the message application optimizes subsequent error corrections presented to the user.

5. The method of claim 1, wherein the messaging application utilizes grammar analysis to determine a proper word usage in the event identical keystrokes from the input protocol results in a plurality of properly spelled words; and
wherein the grammar analysis uses word usage context and related user information including, but not limited to, calendar entries and Web browsing history.
